(19) United States
(12) Patent Application Publication
(10) Pub. No.: US 2017/0186105 A1
(43) Pub. Date: Jun. 29, 2017

(54) METHOD TO INSPECT EQUIPMENT

(71) Applicant: Smith and Turner Development LLC, Katy, TX (US)

(72) Inventors: Lonnie L. Smith, Katy, TX (US); Cody Lee Turner, Tuttle, OK (US)

(73) Assignee: Smith and Turner Development LLC, Katy, TX (US)

(21) Appl. No.: 15/249,399

(22) Filed: Aug. 27, 2016

Related U.S. Application Data
(63) Continuation-in-part of application No. 14/015,139, filed on Aug. 30, 2013, now abandoned.
(60) Provisional application No. 62/211,942, filed on Aug. 31, 2015.
(60) Provisional application No. 61/694,948, filed on Aug. 30, 2012.

(51) Int. Cl. G06Q 50/02; G06Q 30/00

(52) U.S. Cl. CPC G06Q 50/02; G06Q 30/018

(57) ABSTRACT

A method to inspect equipment and a system configured for perpetration of the method. Data relevant to a subject equipment item inspection are entered into an inspection system comprising the inspection interface electronically coupled to an electronic database of data relevant to equipment inspection. The proper inspection protocol, the inspector's suitability for conducting the inspection are automatically determined, inspection reports and other electronic documents necessary to conduct the inspection are generated, and the suitability of the inspected equipment is automatically determined, stored and communicated.

### RELATED APPLICATIONS

This application claims priority to U.S. provisional patent application No. 62/211,942, filed Aug. 31, 2015, and is a continuation-in-part of co-pending U.S. patent application Ser. No. 14/015,139, filed Aug. 30, 2013, which claims priority to U.S. provisional patent application No. 61/694,948, filed Aug. 30, 2012, and all of which are fully incorporated by reference herein.

### BACKGROUND

The statements in this section merely provide background information related to the present disclosure and may not constitute prior art.

Various pieces of equipment, in particular oil field equipment must be inspected at regular intervals according to various methods and procedures to comply with regulatory guidelines and to ensure the piece of equipment is suitable for an intended purpose. Such inspections are typically paper based systems which involve numerous copies of inspection reports and the like, which are not readily searchable, indexed, or befitting to electronic communication. Furthermore, such inspections are subject to human error, wherein the inspector lacks the appropriate certification to conduct the inspection, or the inspection equipment is not suitable for use according to predefined standards, resulting in a faulty inspection being conducted.

### SUMMARY

Embodiments disclosed herein are directed to an equipment inspection system and a method of inspecting equipment and tracking, communicating, or referencing inspection information in a manner amenable to electronic storage, communication, or a combination thereof. Furthermore, the inspection system and methods disclosed herein may function as a gatekeeper, preventing inappropriate inspections from being conducted at a remote location.

In an embodiment, a method to conduct an on-site inspection of a piece of oilfield equipment comprises: providing an electronic inspection system comprising an interface device comprising a portable electronic device interfaced with an electronic database of a central computer system via wired electronic communication, wireless electronic communication, cloud-based electronic communication, internet based electronic communication, email communication, or a combination thereof; and utilizing electronic storage and electronic communication between the interface device and the central computer system for: i) receiving a request to inspect a piece of equipment; ii) entering the request to inspect the piece of equipment into the electronic database; iii) receiving information from an inspector via the interface device associated with an identity of the piece of equipment; iv) identifying the piece of equipment in the electronic database or receiving input from the inspector via the interface device to include the piece of equipment in the electronic database; v) automatically determining an appropriate inspection method for the piece of equipment based on the identification of the piece of equipment according to one or more predetermined standards; vi) determining if the inspector has a certification to conduct the determined inspection method according to one or more predetermined standards; vii) if the inspector is determined not to have the certification to conduct the determined inspection method, providing an indication to the inspector via the interface device not to conduct the inspection, and automatically preventing the interface device from generating an electronic inspection ticket on the interface device for the determined inspection method, thereby preventing the inspector from inspecting the piece of equipment according to the determined inspection method; viii) if the inspector is determined to have the certification to conduct the determined inspection method, automatically generating the electronic inspection ticket on the interface device for conducting the determined inspection method on the piece of equipment, thereby allowing the inspector to inspect the piece of equipment according to the determined inspection method; ix) receiving into the electronic database, inspection information entered by the inspector into one or more required fields of the electronic inspection ticket via the interface device relative to the inspection of the piece of equipment according to the determined inspection method; x) automatically determining an acceptability or an unacceptability for use of the piece of equipment for an intended purpose according to the determined inspection method, based on the inspection information entered into the one or more required fields of the electronic inspection ticket by the inspector; and xi) storing the inspection information and the determination of the acceptability or unacceptability for use of the piece of equipment for the intended purpose according to the determined inspection method in the electronic database associated with the identification of the piece of equipment, and further associated with a time stamp, a revision number, an author, a geographical location, a biometric identifier, or a combination thereof.

In an embodiment, an inspection system to conduct an on-site inspection of a piece of oilfield equipment comprises a central computer system comprising an electronic database in communication and interfaced with a portable electronic device, the system configured to: i) receive a request to inspect a piece of equipment; ii) enter the request to inspect the piece of equipment into the electronic database; iii) receive information from an inspector via the interface device associated with an identity of the piece of equipment; iv) identify the piece of equipment in the electronic database or receive input from the inspector via the interface device to include the piece of equipment in the electronic database; v) automatically determine an appropriate inspection method for the piece of equipment based on the identification of the piece of equipment according to one or more predetermined standards; vi) determine if the inspector has a certification to conduct the determined inspection method according to one or more predetermined standards; vii) if the inspector is determined not to have the certification to conduct the determined inspection method, provide an indication to the inspector via the interface device not to conduct the inspection, and automatically prevent the interface device from generating an electronic inspection ticket on the interface device for the determined inspection method, thereby preventing the inspector from inspecting the piece of equipment according to the determined inspection method; viii) if the inspector is determined to have the certification to conduct the determined inspection method, automatically generate the electronic inspection ticket on the interface device for conducting the determined inspection method on the piece of equipment, thereby allowing the inspector to inspect the piece of equipment according to the determined inspection method; ix) receive into the electronic database, inspection information entered by the inspector into one or more required fields of the electronic inspection ticket via the interface device relative to the inspection of the piece of equipment according to the determined inspection method; x) automatically determine an acceptability or an unacceptability for use of the piece of equipment for an intended purpose according to the determined inspection method, based on the inspection information entered into the one or more required fields of the electronic inspection ticket by the inspector; and xi) store the inspection information and the determination of the acceptability or unacceptability for use of the piece of equipment for the intended purpose according to the determined inspection method in the electronic database associated with the identification of the piece of equipment, and further associated with a time stamp, a revision number, an author, a geographical location, a biometric identifier, or a combination thereof.

### BRIEF DESCRIPTION OF THE SEVERAL VIEWS OF THE DRAWINGS

FIG. 1 is a graphical representation of an inspection system according to an embodiment of the instant disclosure;

FIG. 2 is a flowchart showing the elements of inspection ticketing according to a method of an embodiment of the instant disclosure;

FIG. 3 is a flowchart showing the elements of inspector credentialing according an inspection ticket generation and communication to a method of an embodiment of the instant disclosure;

FIG. 4 is a flowchart showing the elements of instrument certification according to a method of an embodiment of the instant disclosure;

FIG. 5 is a flowchart showing the elements of instrument calibration according to a method of an embodiment of the instant disclosure;

FIG. 6 is a flowchart showing the elements of assembly inspection according to a method of an embodiment of the instant disclosure;

FIG. 7 is a flowchart showing the elements of invoicing according to a method of an embodiment of the instant disclosure; and

FIG. 8 is a graphical representation of an inspection system according to an embodiment of the instant disclosure.

### DETAILED DESCRIPTION

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the system used/disclosed herein can also comprise some components other than those cited.

For purposes herein, an electronic database refers to the program operating a computer system such that the computer functions as a database, and further includes all of the necessary processors, memory, storage, communication equipment, input equipment, peripheral equipment, programming, and functionality necessary for the computer to operate as an electronic database according to the instant disclosure.

While the instant disclosure is generally directed to conducting an on-site inspection of a piece of oilfield equipment, it is to be understood that the method and system disclosed herein is equally suited to conducting inspections of equipment utilized in a variety of fields, and in embodiments, is not strictly limited to use for conducting inspections of oilfield equipment.

In an embodiment, a method to conduct an on-site inspection of a piece of oilfield equipment comprises providing an electronic inspection system comprising an interface device comprising a portable electronic device interfaced with an electronic database of a central computer system via wired electronic communication, wireless electronic communication, cloud-based electronic communication, internet based electronic communication, email communication, or a combination thereof; and utilizing electronic storage and electronic communication between the interface device and the central computer system for:
receiving a request to inspect a piece of equipment;
entering the request to inspect the piece of equipment into the electronic database;
receiving information from an inspector via the interface device associated with an identity of the piece of equipment;
identifying the piece of equipment in the electronic database or receiving input from the inspector via the interface device to include the piece of equipment in the electronic database;
automatically determining an appropriate inspection method for the piece of equipment based on the identification of the piece of equipment according to one or more predetermined standards;
determining if the inspector has a certification to conduct the determined inspection method according to one or more predetermined standards;
if the inspector is determined not to have the certification to conduct the determined inspection method, providing an indication to the inspector via the interface device not to conduct the inspection, and automatically preventing the interface device from generating an electronic inspection ticket on the interface device for the determined inspection method, thereby preventing the inspector from inspecting the piece of equipment according to the determined inspection method;
if the inspector is determined to have the certification to conduct the determined inspection method, automatically generating the electronic inspection ticket on the interface device for conducting the determined inspection method on the piece of equipment, thereby allowing the inspector to inspect the piece of equipment according to the determined inspection method;
receiving into the electronic database, inspection information entered by the inspector into one or more required fields of the electronic inspection ticket via the interface device relative to the inspection of the piece of equipment according to the determined inspection method;
automatically determining an acceptability or an unacceptability for use of the piece of equipment for an intended purpose according to the determined inspection method, based on the inspection information entered into the one or more required fields of the electronic inspection ticket by the inspector; and
storing the inspection information and the determination of the acceptability or unacceptability for use of the piece of equipment for the intended purpose according to the determined inspection method in the electronic database associated with the identification of the piece of equipment, and further associated with a time stamp, a revision number, an author, a geographical location, or a combination thereof.

In embodiments, the receiving inspection information entered by the inspector into one or more required fields of the electronic inspection ticket via the interface device is prevented from proceeding to automatically determining the acceptability or the unacceptability for use of the piece of equipment for the intended purpose according to the determined inspection method until all the required fields of the electronic inspection ticket are populated according to the determined inspection method.

In embodiments, the electronic storage and electronic communication between the interface device and the central computer system further comprises:

I. receiving information from the inspector via the interface device related to an identity of an inspection instrument designated by the inspector for use in inspecting the piece of equipment according to the determined inspection method;

II. identifying the inspection instrument in the electronic database or receiving input from the inspector via the interface device to include the inspection instrument in the electronic database;

III. automatically determining if the identified inspection instrument is in proper calibration according to the determined inspection method;

IV. if the identified inspection instrument is determined to be in proper calibration according to the determined inspection method, automatically generating the electronic inspection ticket on the interface device for conducting the determined inspection method on the piece of equipment;

V. if the identified inspection instrument is determined not to be in proper calibration according to the determined inspection method, providing an indication to the inspector that the identified inspection instrument is not in proper calibration, preventing the generation of the electronic inspection ticket, and optionally generating an electronic calibration ticket for calibrating the identified inspection instrument according to predefined standards, thereby preventing the inspector from conducting the determined inspection method and optionally allowing the inspector to calibrate the inspection instrument according to the determined inspection method, followed by again determining if the identified inspection instrument is in proper calibration according to the determined inspection method.

In embodiments, the determining if the identified inspection instrument is in proper calibration according to the determined inspection method comprises performing a system effectiveness test according to predefined standards, entering data from the system effectiveness test into one or more required fields of the calibration ticket via the interface device, and determining an acceptability or an unacceptability of the calibration of the identified inspection instrument for conducting the determined inspection method according to predefined standards, based on the data entered into the one or more required fields of the calibration ticket by the inspector.

In embodiments, the request received to inspect the piece of equipment is an automated request originated by the electronic database according to one or more predetermined standards, a period of time, an actual usage, a calculated usage, or a combination thereof.

In embodiments, the receiving a request to inspect a piece of equipment; the entering the request to inspect the piece of equipment into the electronic database; the receiving information from an inspector via the interface device associated with an identity of the piece of equipment; the identifying the piece of equipment in the electronic database or the receiving input from the inspector via the interface device to include the piece of equipment in the electronic database; the automatically determining the appropriate inspection method for the piece of equipment based on the identification of the piece of equipment according to one or more predetermined standards; the determining if the inspector has a certification to conduct the determined inspection method according to one or more predetermined standards; if the inspector is determined not to have the certification to conduct the determined inspection method, the providing the indication to the inspector via the interface device not to conduct the inspection, and the automatically preventing the interface device from generating an electronic inspection ticket on the interface device for the determined inspection method, thereby preventing the inspector from inspecting the piece of equipment according to the determined inspection method; if the inspector is determined to have the certification to conduct the determined inspection method, the automatically generating the electronic inspection ticket on the interface device for conducting the determined inspection method on the piece of equipment, thereby allowing the inspector to inspect the piece of equipment according to the determined inspection method; the receiving into the electronic database, inspection information entered by the inspector into the one or more required fields of the electronic inspection ticket via the interface device relative to the inspection of the piece of equipment according to the determined inspection method; the automatically determining the acceptability or the unacceptability for use of the piece of equipment for the intended purpose according to the determined inspection method, based on the inspection information entered into the one or more required fields of the electronic inspection ticket by the inspector; the storing the inspection information and the determination of the acceptability or unacceptability for use of the piece of equipment for the intended purpose according to the determined inspection method in the electronic database associated with the identification of the piece of equipment and further associated with a time stamp, a revision number, an author, a geographical location, or a combination thereof, consists essentially of electronic storage, electronic communication, or a combination thereof.

In embodiments, the one or more predetermined standards, the one or more determined inspection methods, or a combination thereof, comprise legislated standards, standards adopted or recommended by one or more governmental agencies, trade agencies, API standards, ASNT standards, OSHA standards, or a combination thereof.

In embodiments, the method may further comprise creating a digital billing authorization for the inspection associated with the inspection information relative to the piece of equipment in the electronic database; receiving a billing authorization for the digital billing authorization into the electronic database via the interface device, or a combination thereof.

In embodiments, the inspection information relative to the piece of equipment received into the electronic database, the information relative to the piece of equipment already present in the electronic database, or a combination thereof, includes an electronic image of the piece of equipment.

In embodiments, the inspection information relative to the piece of equipment in the electronic database, the information relative to the piece of equipment already present in the electronic database, or a combination thereof, is associated with a serialized list, an equipment status, a repair history, a calibration schedule, an employee, a biometric indicator, a master item list, a content management list, a user permission, an email address, a certification, an equipment assignment, an equipment location, an employee location, a geographical location, a regulatory requirement, or a combination thereof.

In embodiments, the method further comprises physically marking the piece of equipment with an indication related to the acceptability or the unacceptability for use of the piece of equipment for the intended purpose according to the determined inspection method. In embodiments, the electronic database comprises a plurality of interrelated electronic databases.

In embodiments, the method further comprises providing access to an authorized party to at least a portion of the inspection information relative to the piece of equipment in the electronic database, to information relative to the piece of equipment already present in the electronic database, or a combination thereof. In embodiments, the authorized party is an equipment manufacturer, an owner or assignee of the piece of equipment, a regulatory agency, a trade organization, or any combination thereof. In embodiments, the portion of the inspection information relative to the piece of equipment in the electronic database, the portion of information relative to the piece of equipment already present in the electronic database, or a combination thereof, which is provided to the authorized party is based on a previously defined relationship between the authorized party and the piece of equipment.

In embodiments, the inspector is identified in the inspection system by providing a biometric identifier to the interface device comprising a fingerprint scan, a retinal scan, a voice recognition scan, or a combination thereof.

In an embodiment, the electronic database may further comprise inspector credential data associated with respective inspector identifiers, and minimum inspector credential requirements for conducting inspection tests to be performed on respective equipment items according to predefined standards. In embodiments, the inspector may provide a biometric identifier through the portable electronic device, e.g., a digital finger print, a retinal scan, a voice recognition, or the like, allowing the system to properly identify the inspector. The method may further comprise entering an inspector identifier of an inspector who will conduct the inspection test into the inspection interface to populate one of the data entry fields, automatically comparing in the inspection system, the inspector credential data associated to the inspector identifier to determine if the inspector meets the minimum inspector credential requirements to conduct the inspection test, and communicating the determination to the inspection interface.

In an embodiment, the electronic database may further comprise inspection instrument credential data associated with respective inspection instrument identifiers and minimum inspection instrument credential requirements of inspection instruments required by respective equipment tests according to predefined standards. The method may further comprise entering an inspection instrument identifier of an inspection instrument to be used in conducting the inspection test into the inspection interface to populate another one of the data entry fields, automatically comparing in the inspection system, the inspection instrument credential data associated with the inspection instrument identifier entered into the inspection interface to the minimum inspection instrument credential requirements for the equipment test to be conducted to determine if the inspection instrument is certified for use to conduct the inspection test, and communicating the determination to the inspection interface.

In an embodiment, the electronic database may further comprise inspection instrument calibration data and minimum calibration requirements associated with respective inspection instruments and inspection tests according to predefined standards. The method may further comprise calibrating the inspection instrument to be used in conducting the inspection test to collect calibration data from the inspection instrument being calibrated according to predefined standards; entering the collected calibration data into the inspection interface to populate another one of the data entry fields, automatically comparing in the inspection system, the collected calibration data to the minimum calibration requirements to determine if the inspection instrument is calibrated for use to conduct the inspection test, and communicating the determination to the inspection interface.

In an embodiment, the electronic database may further comprise inspection data and minimum inspection requirements associated with respective inspection tests according to predefined standards. The method may further comprise conducting the inspection test on the subject equipment item to collect inspection data, entering the collected inspection data into the inspection interface to populate another of the data entry fields with the collected inspection data, and automatically comparing in the inspection system, the collected inspection data to the minimum inspection requirements associated with the inspection test to determine if the subject equipment item meets the minimum inspection requirements of the inspection test and communicating the determination to the inspection interface, generating an electronic inspection report in the inspection system comprising the determination, communicating the electronic inspection report to the inspection interface, and storing the electronic inspection report in the electronic database.

In an embodiment, the entering of the data into the inspection interface comprises electronic communication between an external data source and the inspection interface which automatically populates a respective data entry field.

In an embodiment, the method may further comprise physically marking the subject equipment item with an indication of the inspection test determination.

In an embodiment, the electronic database may comprise electronic images of respective equipment items, and the method may further comprise entering one or more electronic images of the subject equipment item into the inspection interface.

In an embodiment, the electronic inspection ticket comprises one or more electronic images of the subject equipment item, the electronic inspection report generated by the method comprises one or more electronic images of the subject equipment item, or a combination thereof.

In an embodiment, the method may further comprise electronically notifying one or more clients or other third parties of the presence of the electronic inspection report and providing electronic access by the one or more clients to the electronic inspection report in the electronic database.

In an embodiment, the electronic database is searchable by one or more parameters selected from the group consisting of: equipment item identifier, equipment type, regulatory category, use location, business unit, equipment manufacturer, equipment age, equipment condition, type of damage, equipment cost, inspection date, inspector identifier, inspection report, inspection test, inspection test result, and combinations thereof.

In an embodiment, the electronic database further comprises invoice data associated with respective inspection tests performed on equipment items. The method may further comprise automatically generating an electronic invoice in the inspection system according to one or more parameters related to the inspection test, communicating the electronic invoice to the inspection interface, and storing the electronic invoice in the electronic database.

In an embodiment, the electronic database may further comprise client approval data associated with invoice approval credentials and minimum invoice approval credential requirements according to predefined standards. The method may further comprise communicating the electronic invoice to a client through the inspection interface, via an electronic communication, or both, receiving a client approval identifier associated with the electronic invoice into the inspection system via the inspection interface or via electronic communication to populate another one of the data entry fields associated with invoice approval, automatically comparing in the inspection system, the client approval identifier to the minimum invoice approval credential requirements to determine an approval status of the electronic invoice, communicating the approval status to the inspection interface, and storing the approval status associated with the electronic invoice in the electronic database.

In an embodiment, the electronic database may further comprise test reagent data relevant to an identity of a test reagent required by an inspection test according to predefined standards. The method may further comprise populating one of the data entry fields with data relevant to the identity of a test reagent.

In an embodiment, the electronic database may further comprise equipment assembly data relevant to respective equipment items present in equipment assemblies, and inspection tests to be performed on respective equipment items present in an equipment assembly according to predefined standards. The method may further comprises automatically comparing in the inspection system, the equipment identifier to the equipment assembly data to determine if the subject equipment item is an equipment assembly comprises a plurality of equipment items, each requiring an inspection test, communicating the determination to the inspection interface, automatically generating in the inspection system, one or more electronic inspection tickets for each of the required inspection tests, communicating each of the electronic inspection tickets to the inspection interface, and storing each of the electronic inspection tickets in the electronic database.

In an embodiment, the electronic database may further comprise ancillary data which is unrelated to the requirements of the equipment test. The method may further comprise populating at least one of the ancillary data entry fields. In an embodiment, the ancillary data may include client specific data relevant to equipment location, project, well site, production site, manufacturer, equipment dimension, equipment condition, equipment age, type of damage, equipment test location, invoice information, or a combination thereof.

In an embodiment, an inspection system comprises a central computer system comprising an electronic database in communication with a portable electronic device, the system configured to: receive information to identify a subject equipment item and automatically determine the inspection test to be performed on the subject equipment item according to predetermined standards, receive information to identify an inspector and automatically determine if the inspector meets a minimum inspector credential requirements to conduct the inspection test according to predetermined standards, receive information to identify an inspection instrument and automatically determine if the inspection instrument meets minimum credential requirements for the equipment test to be conducted to determine if the inspection instrument is certified for use to conduct the inspection test according to predetermined standards, receive calibration data of an inspection instrument to be used in conducting the inspection test and automatically determining if the inspection instrument is calibrated for use to conduct the inspection test according to predetermined standards, receive inspection test data obtained by conducting the inspection test on a subject equipment item and automatically determining if the subject equipment item meets the minimum inspection requirements of the inspection test according to predetermined standards and generate an inspection report comprising the determination, or a combination thereof.

In an embodiment, the inspection system, after generating an inspection report, is further configured to automatically generate an electronic invoice according to one or more parameters related to the inspection test and communicate the electronic invoice to a third party according to predetermined standards.

In an embodiment, the inspection system is further configured to receive a client approval identifier associated with the electronic invoice and automatically determine an approval status of the electronic invoice according to predetermined standards.

In an embodiment, the subject equipment item is a piece of equipment of a type typically utilized in an oil field application. As used herein, a particular piece of equipment may refer to a single piece of equipment, or may include an assembly comprising a plurality of individual pieces of equipment. Furthermore, the method may be conducted on a plurality of particular pieces of equipment with a single verification or determination that an identified inspection instrument is in proper calibration according to one or more predetermined standards and/or a single determination that the inspector has certification to conduct the inspection of the piece of subject equipment according to one or more predetermined standards.

In an embodiment, the inspection of the subject equipment item comprises non-destructive testing according to methods, standards, and procedures readily known to the industry in which the subject equipment item is employed. In an embodiment, the inspection of the subject equipment item comprises non-destructive testing according to methods, standards, and procedures readily known to the oil and gas industry. Examples of suitable tests and inspections include magnetic particle testing, liquid penetrant testing, hardness testing, ultrasonic techniques, and the like consistent with various regulations, guidelines, and legislative requirements. In an embodiment, the equipment and inspections are related to down hole assembly equipment, and include standard operating procedures designed for visual inspection of American Petroleum Institute (API) connections and all procedures to insure conformity with American Society of Nondestructive Testing (ASNT) specifications.

In an embodiment, one or more or all inspection equipment, procedures, methods and the like are arranged to meet the standards set out in Standard DS-1® Fourth Edition, T H Hill Associates, Inc., Houston, Tex. (2013), including Volume 1—Drilling Tubular Product Specification, Volume 2—Drill Stem Design and Operation, Volume 3—Drill Stem Inspection, and/or Volume 4—Drilling Specialty Tools, or an equivalent thereof. In an embodiment, all certifications of inspectors and inspection equipment comply with or exceed ASNT standards for certification, or an equivalent thereof.

The electronic database of the method, the system, and the like according to an embodiment are arranged to provide immediate real-time billing and inspection information to a party. In an embodiment, such information is readily available from essentially anywhere on the globe. In an embodiment, the electronic system and/or method disclosed herein are suitable for use in a variety of purposes, environments, and businesses utilizing a secure web based platform that can access all field inspection tickets or records, billing authorizations, and/or other important information related to the inspection, collectively referred to herein as data and/or information associated with the subject equipment item. In an embodiment, an authorized party, which may be a customer of the electronic database manager, a client of an inspection service, the owner, manager, lessee, lessor of the subject equipment item, a regulatory entity, a trade-group, and/or the like, may build customized reports, mine data, and utilize information associated with one or more pieces of equipment to assist in product design, specifications, failure analysis, operational parameters, safety guidelines, litigation, inventory control, planning, purchasing, and/or the like. In an embodiment, the system and methods disclosed herein are designed to enable and enhance the tracking of calibration data for equipment, linking inspection processes to appropriate procedures, and the like. In an embodiment an amount of detail provided to the authorized party is based on a relationship of the piece of subject equipment to the authorized party. For example, the physical owner, location, amount, or the like of particular pieces of equipment may be obfuscated or the data sanitized to remove information of a private or competitive nature prior to the data being made available to a particular party, or classification of third parties.

In an embodiment, the electronic database comprises a plurality of interrelated electronic databases. In an embodiment the inspection interface between the inspector and the electronic database is a portable computing device which can be interfaced with one or more central and/or stationary computing devices, e.g., servers, data farms, and/or the like.

In an embodiment the inspection interface between the inspector and the electronic database comprises wired electronic communication, wireless electronic communication, cloud based electronic communication, internet based electronic communication, email, or a combination thereof. In an embodiment, essentially no human intervention is necessary to enter the data provided to the inspection interface into the database.

In an embodiment, the inspection interface is a portable electronic device. Suitable inspection interfaces include dedicated electronic inspection devices, smart-phones, tablets, notebook computers, personal computers, and the like, configured to run an appropriate application to function as an inspection device.

In an embodiment, the database comprises a plurality of data, which may be cross-referenced with any one of a plurality of data fields and/or other identifiers. In an embodiment the information associated with the subject equipment item in the electronic database is associated with a serialized list, an equipment status, a repair history, a calibration schedule, an employee, a master item list, a content management list, a user permission, an email address, a certification, an equipment assignment, an equipment location, an employee location, or a combination thereof. Such information may be further cross-indexed or arranged with other databases, both public and private, related to such equipment or processes.

In an embodiment the information received by, and/or present in the electronic database is associated with a time stamp, a revision number, an author, or a combination thereof to provide an audit trail and to insure the integrity of the information present. The database and/or communications may be further encrypted to ensure the integrity of the data.

In an embodiment, the database comprises a plurality of data comprising information related to inspection test data relevant to respective inspection tests to be performed on a plurality of equipment items according to predefined standards, inspector credential data associated with respective inspector identifiers, minimum inspector credential requirements for conducting inspection tests to be performed on respective equipment items according to predefined standards, inspection instrument credential data associated with respective inspection instrument identifiers, minimum inspection instrument credential requirements of inspection instruments required by respective equipment tests according to predefined standards, inspection instrument calibration data, minimum calibration requirements associated with respective inspection instruments and inspection tests according to predefined standards, inspection data and minimum inspection requirements associated with respective inspection tests according to predefined standards, electronic images of respective equipment items, invoice data associated with respective inspection tests performed on equipment items, client approval data associated with invoice approval credentials, minimum invoice approval credential requirements according to predefined standards, test reagent data relevant to an identity of a test reagent required by an inspection test, equipment assembly data relevant to respective equipment items present in equipment assemblies, inspection test data relative to the inspection tests to be performed on respective equipment items present in an equipment assembly according to predefined standards, client specific ancillary data which is unrelated to the requirements of equipment tests, or any combination thereof.

In an embodiment the inspection system, and/or a method which utilizes the inspection system may receive, or may generate a request to inspect a subject equipment item via an automated request originated by the electronic database according to one or more predetermined standards, a period of time, an actual usage, a calculated usage, or a combination thereof. In an embodiment, the request may comprise a master overall order or inspection plan, wherein items are inspected according to embodiments disclosed herein as they arrive at or depart from one or more locations. In an embodiment the request to inspect the piece of subject equipment, the information from the inspector associated with the identity of the subject equipment item, the information from the inspector related to the inspection test, the inspector, inspection instruments, instrument calibration, the inspection of the subject equipment item, invoices, inspection reports, and the like, are stored in the electronic database associated with the at least one indicator, the access provided to the authorized party to at least a portion of the inspection information in the electronic database associated with the at least one indicator, or a combination thereof, such that the inspection system comprises or consists essentially of electronic storage, electronic communication, or a combination thereof. In an embodiment, the methods and systems disclosed herein represent an essentially paperless system as is possible relative to governmental and industrial standards and reporting requirements. In an embodiment, invoice approvals may include pre-approvals according to various criteria and predetermined standards.

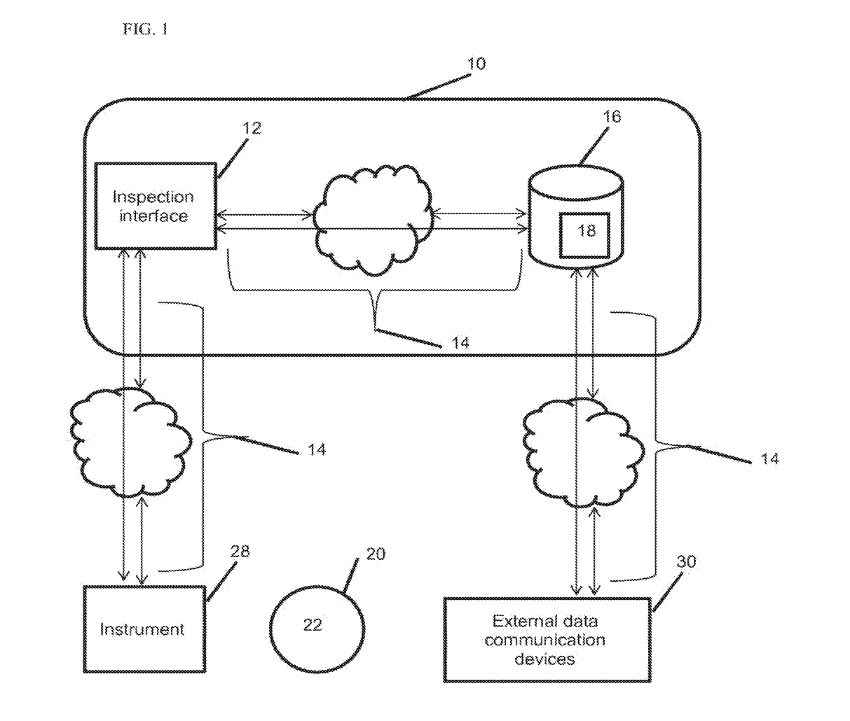

As shown in FIG. 1, in an embodiment, an inspection system 10 comprises an inspection interface 12 electronically coupled in wired and/or wireless electronic communication 14 to an electronic database 16 comprising a plurality of data 18, which, in an embodiment, may include inspection test data relevant to respective inspection tests to be performed on an equipment item 20 according to predefined standards. In an embodiment, the inspection system 10 may further include one or more external data communication devices 30, which are in wired or wireless electronic communication 14 with the electronic database 16. In an embodiment, the inspection interface 12 may be in electronic communication 14 with an instrument 28 utilized to perform an inspection test. In an embodiment, the equipment item 20 includes an equipment identifier 22, or may be assigned an equipment identifier, e.g., by the client, inspector and/or the inspection system.

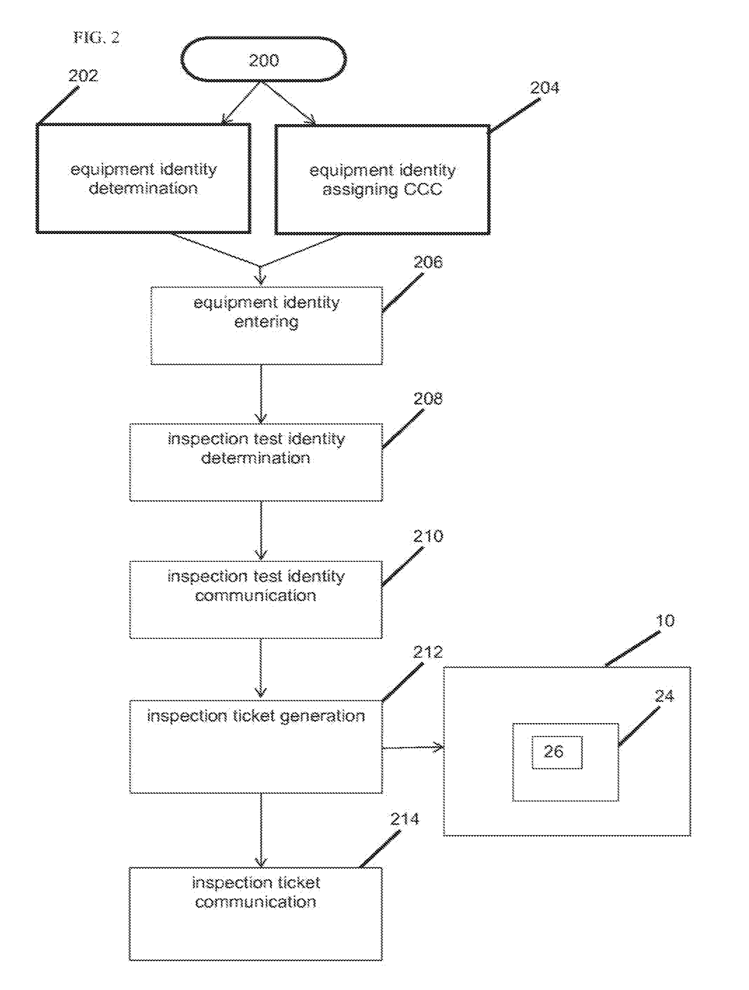

As shown in FIG. 2, in an embodiment, a method, generally referred to as 200 comprises an equipment identity determination step 202, comprising determining an equipment identifier 22 of an equipment item 20 and/or associated with the equipment item 20 or an equipment identity assigning step 204, comprising assigning an equipment identifier 22 to the equipment item 20. The method may further comprise an equipment identity entering step 206 wherein the equipment identifier 22 is entered into the inspection interface 12 of the inspection system 10 (see FIG. 1). In an embodiment, the equipment identifier may comprise a visually scanable identifier (e.g., a bar code), an electronically readable identifier, e.g., an RFID tag, a serial number, an equipment tag, or any combination thereof. In an embodiment, the method or inspection interface 12 may be locked, i.e., prevented from proceeding further, until the equipment identifier is determined or assigned. At various point or steps within the instant method, actions required to properly inspect a piece of equipment may be monitored by the system. When an action is inconsistent with, or violates the requirements of an inspection method or some other facet of the system, the system may be locked, e.g., prevented from proceeding to the next step. In embodiments, the system may be unlocked to resume the inspection once the issue has been corrected. Accordingly, in contrast to other methods and systems known in the art, the instant methods and system may function as a gate-keeper, preventing an improper inspection from ever taking place regardless of human action.

In an embodiment, method 200 may further comprise an inspection test identity determination step 208, wherein the inspection system 10 automatically compares the equipment identifier 22 to the inspection test data of the plurality of data 18 present in the database 16 to determine the inspection test to be performed on the equipment item 20 according to predefines standards. Method 200 may further include an inspection test identity communication step 210, wherein the determination of the inspection test to be performed on the equipment and all of the associated information required by the inspector to inspect the item is communicated to the inspection interface 12, and/or made available to the inspector via the inspector interface 12. In an embodiment, method 200 may further include an inspection ticket generation step 212, wherein the inspection system 10 generates an electronic inspection ticket 24 in the inspection system 10 comprising a plurality of data entry fields 26 relevant to the determined inspection test. The method may further comprise an inspection ticket communication step 214, wherein the electronic inspection ticket 24 is communicated to the inspection interface 12 and stored in the electronic database 16 relative to one or more identifiers associated with this inspection. Likewise, all data subsequently entered into the electronic database relevant to the electronic inspection ticket 24, either entered directly into the inspection interface 12 by populating data entry fields 26, and/or entered by electronic communication of an instrument 28 with the inspection interface 12, and/or entered remotely via an external data connection 30 such as an email or other data entry method, and/or the like, is stored in the electronic database 16 such that the data are associated at least with at least one identifier. In an embodiment, the data identifier is the electronic inspection ticket 24. In an embodiment, the method or inspection interface 12 may be locked, i.e., prevented from proceeding further, until the electronic inspection ticket 24 is communicated to or otherwise populated in the inspection interface 12.

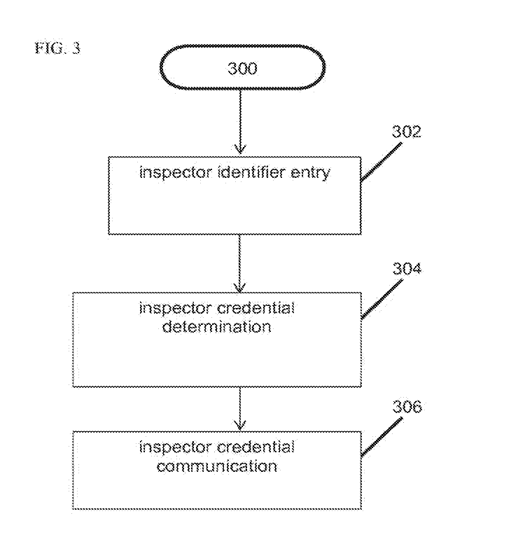

In an embodiment, the plurality of data 18 of the electronic database 16 may further comprise inspector credential data associated with respective inspector identifiers, and minimum inspector credential requirements for conducting an inspection test to be performed on respective equipment items according to predefined standards. As shown in FIG. 3, in an embodiment, any method disclosed herein, generally represented in FIG. 3 as method 300, may further comprise an inspector identifier entering step 302, wherein an inspector identifier of an inspector who will conduct the inspection test is entered into the inspection interface 12 e.g. entering the data into inspection ticket 24 to populate one of the data entry fields 26. This may be an electronic signature, an electronic authorization provided by electronic commerce, a biometric identifier such as a fingerprint, a retinal scan, voice recognition, a user name and associated password, and/or other indication readily understood by one of minimal skill in the art. In an embodiment, the method or inspection interface 12 may be locked, i.e., prevented from proceeding further, until the inspector identifier is entered.

In an embodiment, method 300 may further comprise an inspector credential determination step 304, wherein the inspection system 10 automatically compares the inspector credential data associated with or to the inspector identifier to determine if the inspector meets minimum inspector credential requirements to conduct the inspection test according to predefined standards. The method may further include an inspector credential communication step 306, comprising communicating the determination of the suitability of the inspector's credentials to conduct the equipment test to the inspection interface 12 and storing in the data in database 16 associated at least with the electronic inspection ticket 24. In an embodiment, the method or inspection interface 12 may be locked, i.e., prevented from proceeding further, in the event the inspector's credentials are not qualified to conduct the relevant test(s). Accordingly, the instant system and method may function as a gate keeper which prevents an improper inspection from taking place by preventing the generation of the inspection ticket required by the inspector to conduct the inspection.

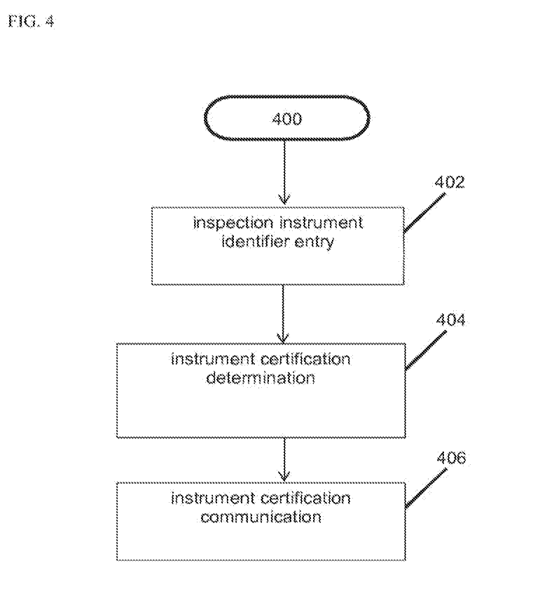

In an embodiment, the plurality of data 18 of the electronic database 16 may further comprise inspection instrument credential data associated with respective inspection instrument identifiers and minimum inspection instrument credential requirements of inspection instruments required by respective equipment tests according to predefined standards. In an embodiment as shown in FIG. 4, any method disclosed herein, generally represented as 400, may further comprise an inspection instrument identifier entering step 402, wherein an inspection instrument identifier of an inspection instrument 28 to be used in conducting the inspection test is entered into the inspection interface 12 to populate another one of the data entry fields 26 in the inspection ticket 24. Method 400 may further comprise an instrument certification determination step 404, wherein the inspection system 10 automatically compares the inspection instrument credential data associated with the inspection instrument identifier entered into the inspection interface to the minimum inspection instrument credential requirements for the equipment test to be conducted to determine if the inspection instrument 28 is certified for use to conduct the inspection test.

Method 400 may further comprise an instrument certification communication step 406, comprising communicating the determination of the suitability of the inspection instrument credentials to conduct the equipment test to the inspection interface 12 and storing in the determination in database 16 associated at least with the electronic inspection ticket 24. In an embodiment, the method or inspection interface 12 may be locked, i.e., prevented from proceeding further, in the event the instrument credentials do not meet the requirements to conduct the relevant test(s), and/or the inspector may be prompted to verify the instrument credentials.

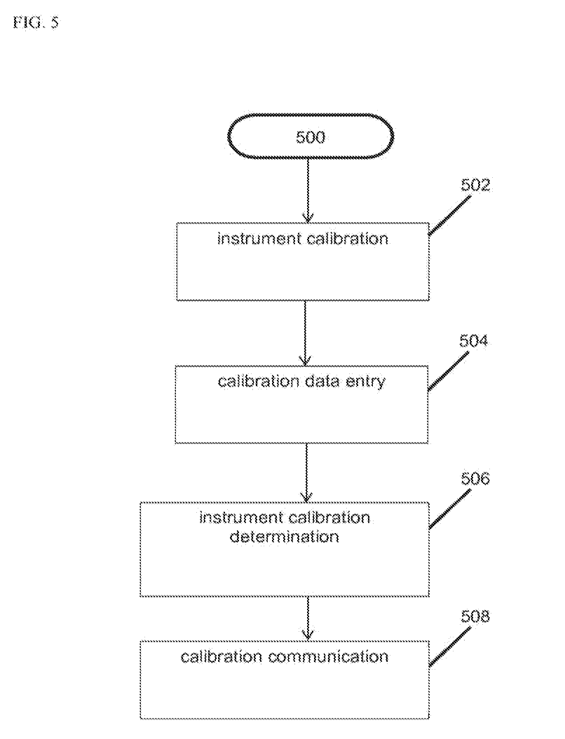

In an embodiment, the plurality of data 18 of the electronic database 16 may further comprise inspection instrument calibration data and minimum calibration requirements associated with respective inspection instruments and inspection tests according to predefined standards. In an embodiment as shown in FIG. 5, any method disclosed herein in which an instrument is used, generally represented as 500, may further comprise an instrument calibration step 502, wherein an inspection instrument to be used in conducting the inspection test is calibrated and calibration data is collected from the inspection instrument being calibrated according to predefined standards. Method 500 may further comprise a calibration data-entering step 504, wherein the collected calibration data is entered into the inspection interface 12 of the inspection system 10 to populate another one of the data entry fields 26 of the inspection ticket 24.

In embodiments, method 500 may further include an instrument calibration determination step 506, wherein the inspection system 10 automatically compares the entered calibration data to the minimum calibration requirements to determine if the inspection instrument is calibrated for use to conduct the inspection test according to predefines standards. Method 500 may also include a calibration communication step 508, comprising communicating the determination of the calibration status of the instrument to the inspection interface 12, and storing the determination data in the database 16 associated at least with the electronic inspection ticket 24. In an embodiment, the entering of the calibration data into the inspection system 10, e.g., via the inspection interface 12 may comprise electronic communication 14 between the instrument 28, and/or an external data source associated with the instrument 28, and the inspection interface 12 which automatically populates a respective data entry field 26 of the inspection ticket 24. This may include wired or wireless electronic communication (see FIG. 1). In an embodiment, the method or inspection interface 12 may be locked, i.e., prevented from proceeding further, in the event the instrument calibration data do not meet requirements for the relevant test(s), or the inspector may be prompted to verify the instrument calibration data.

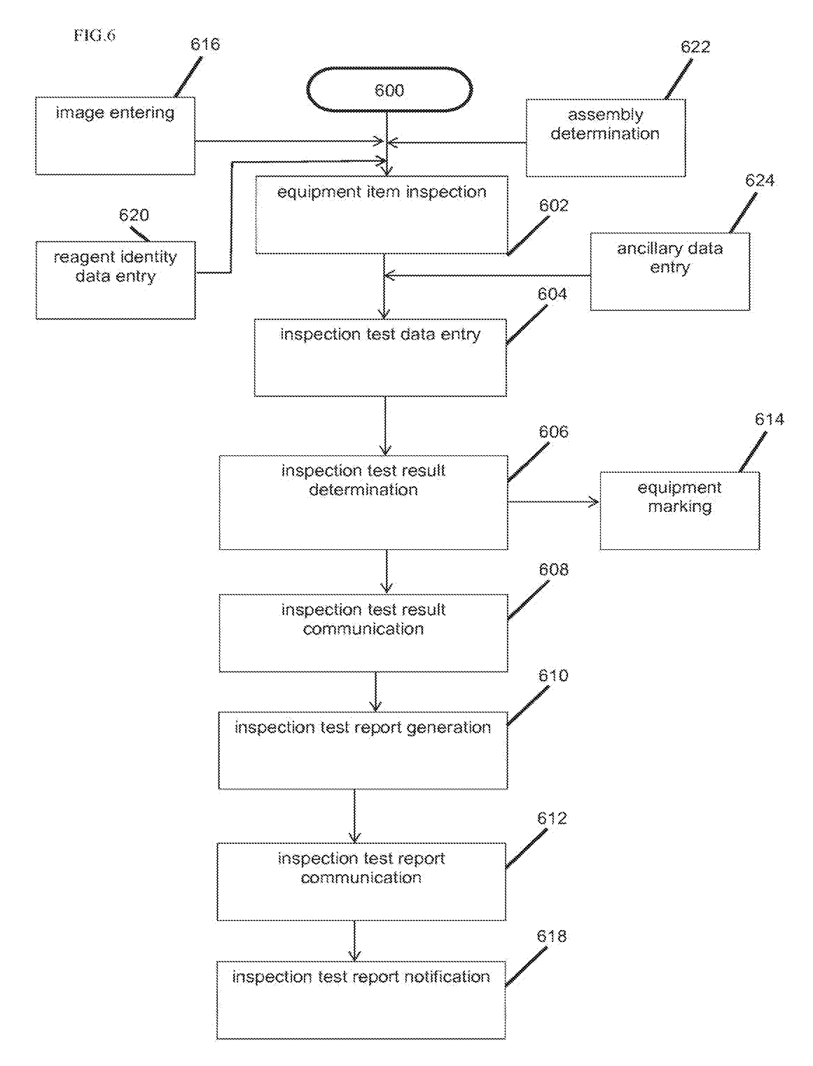

In an embodiment, the plurality of data 18 of the electronic database 16 may further comprise inspection data and minimum inspection requirements associated with respective inspection tests according to predefined standards. As shown in FIG. 6, in an embodiment, any method disclosed herein generally represented as 600, may further comprise an equipment item inspection step 602, comprising conducting the inspection test on the subject equipment item and collecting inspection data according to predefined standards. Method 600 may further comprise an inspection test data entering step 604, comprising entering the collected inspection test data into the inspection interface, e.g., via inspection ticket 24 to populate another of the data entry fields 26 with the collected inspection data.

In embodiments, method 600 may further include an inspection test result determination step 606, wherein the inspection system 10 automatically compares the collected inspection data to the minimum inspection requirements associated with the inspection test to determine if the subject equipment item meets the minimum inspection requirements of the inspection test, e.g., pass or fail, according to predefined standards. Method 600 may also include an inspection test result communication step 608, comprising communicating the inspection test result determination to the inspection interface 12, and storing the determination result data in the database 16 associated at least with the electronic inspection ticket 24. In an embodiment, the method or inspection interface 12 may be locked, i.e., prevented from finalizing or closing out, in the event the inspection data entered do not meet the minimum inspection requirements, or the inspector may be prompted to enter the required data in the event an inspection report, invoice or the like is attempted to be prematurely generated.

In an embodiment, method 600 may further comprise an inspection test report generation step 610, comprising generating an electronic inspection report in the inspection system comprising the inspection test result determination. Method 600 may also include an inspection test report communication step 612, comprising communicating electronic inspection report to the inspection interface 12 and storing the electronic inspection report in the database 16 associated at least with the electronic inspection ticket 24. In an embodiment, method 600 may further comprise an equipment marking step 614, comprising physically marking the tested equipment item with an indication of the inspection test result determination. Markings may include color coded paint or other semi-permanent markings such as a green stripe to indicate a passing equipment test result determination and a red x to indicate the failure of an equipment item to meet the minimum requirements of an inspection test according to predefined standards.

In an embodiment, the plurality of data 18 of the electronic database 16 may further comprise test reagent data relevant to an identity of a test reagent required by an inspection test according to predefined standards. In an embodiment, method 600 may further comprise a reagent identity data entering step 620, comprising entering data populating one of the data entry fields with data relevant to the identity of a test reagent according to predefined standards.

In an embodiment, the plurality of data 18 of the electronic database 16 may further comprise equipment assembly data relevant to respective equipment items present in equipment assemblies, and inspection tests to be performed on respective equipment items present in an equipment assembly according to predefined standards. In an embodiment method 600 may further comprise an assembly determination step 622, comprising automatically comparing, in the inspection system, the equipment identifier to the equipment assembly data to determine if the subject equipment item is an equipment assembly comprising a plurality of equipment items, each requiring an inspection test, communicating the assembly determination to the inspection interface, automatically generating in the inspection system, each of the electronic inspection tickets for each of the required inspection tests according to predefined standards, communicating each of the electronic inspection tickets to the inspection interface, and storing each of the electronic inspection tickets in the electronic database.

In an embodiment, the plurality of data 18 of the electronic database 16 may further comprise ancillary data which is unrelated to the requirements of the equipment test. In an embodiment, method 600 may further comprise an ancillary data entering step 624 comprising populating at least one of the ancillary data entry fields 26 present in the inspection ticket 24. In an embodiment, the ancillary data is client specific data relevant to equipment location, project, well site, production site, manufacturer, equipment dimension, equipment condition, equipment age, type of damage, equipment test location, invoice information, or a combination thereof.

In an embodiment, the plurality of data 18 of the electronic database 16 may further comprise electronic images, which may include still images, videos, sound recordings, and/or the like of an equipment item 20. In an embodiment, method 600 may further comprise an image entering step 616, wherein one or more electronic images of the subject equipment item are entered into the inspection interface 12 to populate one or more data entry fields 26 present in the inspection ticket 24. In an embodiment, the inspection ticket generation step 212 (see FIG. 2) the inspection test report generation step 610, or a combination thereof, further comprises inclusion of one or more electronic images of the subject equipment item therein. In an embodiment, the method or inspection interface 12 may be locked, i.e., prevented from proceeding further, until the image(s) are uploaded, or the inspector may be prompted to upload the images.

In an embodiment, method 600 may further comprise an inspection test report notification step 618, comprising electronically notifying one or more clients and/or other third parties of the presence of the electronic inspection report and providing electronic access by the one or more clients or other third parties to the electronic inspection report in the electronic database 16 via an external data communication device 30. Examples of external data communication devices include a computer or other similar device in electronic communication with the database via internet or other wireless communication links, a direct communication link, or any combination thereof. In an embodiment, the electronic database 16 may be searchable by one or more parameters selected from the group consisting of: equipment item identifier, equipment type, regulatory category, use location, business unit, equipment manufacturer, equipment age, equipment condition, type of damage, equipment cost, inspection date, inspector identifier, inspection report, inspection test, inspection test result, and combinations thereof. In an embodiment, the plurality of data 18 of the electronic database 16 may further comprise invoice data associated with respective inspection tests to be performed on an equipment item 20. In an embodiment, the electronic database 16 may further comprise client approval data associated with invoice approval credentials and minimum invoice approval credential requirements according to predefined standards.

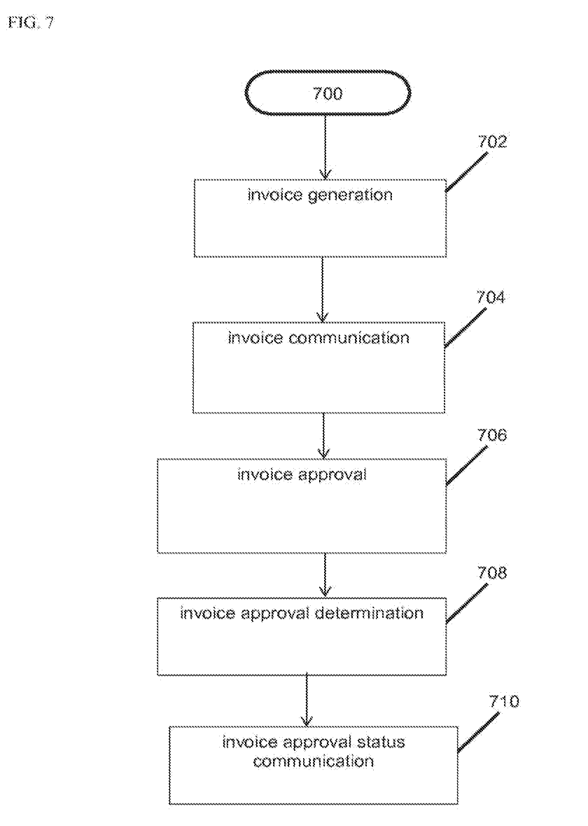

As shown in FIG. 7, in an embodiment, any method disclosed herein generally represented as 700, may further comprise an invoice generation step 702, comprising automatically generating an electronic invoice in the inspection system according to one or more parameters related to one or more inspection tests. Method 700 may also include an invoice communication step 702, comprising communicating the electronic invoice to the inspection interface 12 and/or communicating the electronic invoice to a client via an external electronic communication device 30, such as via email, clearing house, and/or the like, and storing the electronic invoice in the database 16 associated at least with the electronic inspection ticket 24. In an embodiment, method 700 may further comprise an invoice approval step 706, comprising receiving a client invoice approval identifier associated with the electronic invoice into the inspection system 10 via the inspection interface 12 or via an external electronic communication device 30 to populate another one of the data entry fields 26 associated with invoice approval. Method 700 may further comprise an invoice approval determination step 708, comprising automatically comparing, in the inspection system, the client invoice approval identifier to the minimum invoice approval credential requirements to determine an approval status of the electronic invoice, which may be followed by an invoice approval status communication step 710 comprising communicating the approval status of the electronic invoice to the inspection interface 12 and/or to a client via an external data communication device 30 and storing the invoice approval status associated with the electronic invoice in the electronic database 16 associated at least with the electronic inspection ticket.

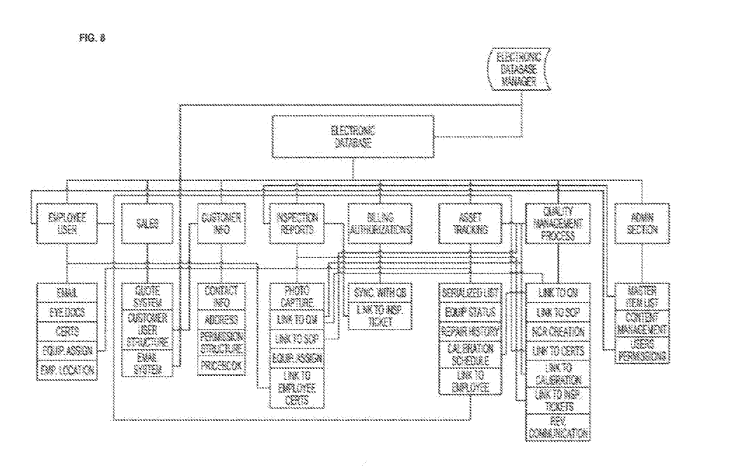

FIG. 8 shows an overview of the various components and interrelationships of an electronic database according to an embodiment of the instant disclosure.

### Embodiments

As is evident from the disclosure herein, a variety of embodiments are contemplated:
M1. A method comprising:
   determining an equipment identifier associated with a subject equipment item or assigning an equipment identifier to the subject equipment item;
   entering the equipment identifier into an inspection interface of an inspection system comprising the inspection interface electronically coupled to an electronic database comprising inspection test data relevant to respective inspection tests to be performed on a plurality of equipment items according to predefined standards; automatically comparing the equipment identifier to the inspection test data to determine the inspection test to be performed on the subject equipment item; communicating the determination to the inspection interface;
   generating an electronic inspection ticket in the inspection system comprising a plurality of data entry fields relevant to the determined inspection test;
   communicating the electronic inspection ticket to the inspection interface; and/or storing the electronic inspection ticket in the electronic database.
M2. The method according to embodiment M1, wherein the electronic database further comprises inspector credential data associated with respective inspector identifiers, and minimum inspector credential requirements for conducting an inspection test to be performed on respective equipment items according to predefined standards, the method further comprising:
   entering an inspector identifier of an inspector who will conduct the inspection test into the inspection interface to populate one of the data entry fields;
   automatically comparing in the inspection system, the inspector credential data associated to the inspector identifier to determine if the inspector meets the minimum inspector credential requirements to conduct the inspection test, communicating the determination of credentials to the inspection interface, and storing the determination of credentials in the database.
M3. The method according to embodiments M1 or M2, wherein the electronic database further comprises inspection instrument credential data associated with respective inspection instrument identifiers and minimum inspection instrument credential requirements of inspection instruments required by respective equipment tests according to predefined standards, and wherein the method further comprises:
   entering an inspection instrument identifier of an inspection instrument to be used in conducting the inspection test into the inspection interface to populate another one of the data entry fields;
   automatically comparing in the inspection system, the inspection instrument credential data associated with the inspection instrument identifier entered into the inspection interface to the minimum inspection instrument credential requirements for the equipment test to be conducted to determine if the inspection instrument is certified for use to conduct the inspection test, communicating the determination of certification to the inspection interface, and storing the determination of certification in the database.
M4. The method according to embodiment M3, wherein the electronic database further comprises inspection instrument calibration data and minimum calibration requirements associated with respective inspection instruments and inspection tests according to predefined standards, and wherein the method further comprises:
   calibrating the inspection instrument to be used in conducting the inspection test to collect calibration data from the inspection instrument being calibrated according to predefined standards;
   entering the collected calibration data into the inspection interface to populate another one of the data entry fields;
   automatically comparing in the inspection system, the collected calibration data to the minimum calibration requirements to determine if the inspection instrument is calibrated for use to conduct the inspection test, communicating the determination of calibration to the inspection interface, and storing the determination of calibration in the database.
M5. The method according to any one of embodiments M1 through M4, wherein the electronic database further comprises inspection data and minimum inspection requirements associated with respective inspection tests according to predefined standards, and wherein the method further comprises:
   conducting the inspection test on the subject equipment item to collect inspection data;
   entering the collected inspection data into the inspection interface to populate another of the data entry fields with the collected inspection data; and
   automatically comparing in the inspection system, the collected inspection data to the minimum inspection requirements associated with the inspection test to determine if the subject equipment item meets the minimum inspection requirements of the inspection test and communicating the determination to the inspection interface;
   generating an electronic inspection report in the inspection system comprising the determination of the inspection test;
   communicating the electronic inspection report to the inspection interface; and storing the electronic inspection report in the electronic database.
M6. The method according to any one of embodiments M1 through M5, wherein the entering the data into the inspection interface comprises electronic communication between an external data source and the inspection interface which automatically populates a respective data entry field.
M7. The method according to any one of embodiments M1 through M6, further comprising physically marking the subject equipment item with an indication of the determination of the inspection test.
M8. The method according to any one of embodiments M1 through M7, wherein the electronic database comprises electronic images of respective equipment items, and wherein the method further comprises entering one or more electronic images of the subject equipment item into the inspection interface.
M9. The method according to any one of embodiments M1 through M8, wherein the electronic inspection ticket comprises one or more electronic images of the subject equipment item, wherein the electronic inspection report comprises one or more electronic images of the subject equipment item, or a combination thereof.
M10. The method according to any one of embodiments M1 through M9, further comprising:
   electronically notifying one or more clients of the presence of the electronic inspection report; and
   providing electronic access by the one or more clients to the electronic inspection report in the electronic database.
M11. The method according to any one of embodiments M1 through M10, wherein the electronic database is searchable by one or more parameters selected from the group consisting of: equipment item identifier, equipment type, regulatory category, use location, business unit, equipment manufacturer, equipment age, equipment condition, type of damage, equipment cost, inspection date, inspector identifier, inspection report, inspection test, inspection test result, and combinations thereof.
M12. The method according to any one of embodiments M1 through M11, wherein the electronic database further comprises invoice data associated with respective inspection tests performed on equipment items; and wherein the method further comprises:
   automatically generating an electronic invoice in the inspection system according to one or more parameters related to the inspection test; communicating the electronic invoice to the inspection interface; and/or
   storing the electronic invoice in the electronic database.
M13. The method according to any one of embodiments M1 through M12, wherein the electronic database further comprises client approval data associated with invoice approval credentials and minimum invoice approval credential requirements according to predefined standards, and wherein the method further comprises: communicating the electronic invoice to a client through the inspection interface, via an electronic communication, or both;
   receiving a client approval identifier associated with the electronic invoice into the inspection system via the inspection interface or via electronic communication to populate another one of the data entry fields associated with invoice approval;
   automatically comparing in the inspection system, the client approval identifier to the minimum invoice approval credential requirements to determine an approval status of the electronic invoice; communicating the approval status to the inspection interface; and/or
   storing the approval status associated with the electronic invoice in the electronic database.
M14. The method according to any one of embodiments M1 through M13, wherein the electronic data base further comprises test reagent data relevant to an identity of a test reagent required by an inspection test according to predefines standards, and wherein the method further comprises populating one of the data entry fields with data relevant to the identity of a test reagent.
M15. The method according to any one of embodiments M1 through M14, wherein the electronic database further comprises equipment assembly data relevant to respective equipment items present in equipment assemblies, and inspection tests to be performed on respective equipment items present in an equipment assembly according to predefined standards; and wherein the method further comprises:
   automatically comparing in the inspection system, the equipment identifier to the equipment assembly data to determine if the subject equipment item is an equipment assembly comprising one or more equipment items each requiring an inspection test; communicating the determination of assembly to the inspection interface; automatically generating in the inspection system, one or more electronic inspection tickets for each of the required inspection tests;
   communicating each of the electronic inspection tickets to the inspection interface; and storing each of the electronic inspection tickets in the electronic database.
M16. The method according to any one of embodiments M1 through M15, wherein the electronic data base further comprises ancillary data which is unrelated to the requirements of the equipment test, and wherein the method further comprises populating at least one of the ancillary data entry fields with ancillary data.
M17. The method according to embodiment M16, wherein the ancillary data is client specific data relevant to equipment location, project, well site, production site, manufacturer, equipment dimension, equipment condition, equipment age, type of damage, equipment test location, invoice information, or a combination thereof.
S1. An inspection system comprising:
   a central computer system comprising an electronic database in communication with a portable electronic device, the system configured to:
   receive information to identify a subject equipment item and automatically determine an inspection test to be performed on the subject equipment item according to predetermined standards;
   receive information to identify an inspector and automatically determine if the inspector meets minimum inspector credential requirements to conduct the inspection test according to predetermined standards;
   receive information to identify an inspection instrument and automatically determine if the inspection instrument meets minimum credential requirements for the equipment test to be conducted to determine if the inspection instrument is certified for use to conduct the inspection test according to predetermined standards; receive calibration data of an inspection instrument to be used in conducting the inspection test and automatically determining if the inspection instrument is calibrated for use to conduct the inspection test according to predetermined standards;
   receive inspection test data obtained by conducting the inspection test on a subject equipment item and automatically determining if the subject equipment item meets minimum inspection requirements of the inspection test according to predetermined standards, generate an inspection report comprising the determination, communicate the inspection report to a third party; or a combination thereof, and/or the inspection system is configured to store at least one determination and/or an electronic document associated with an inspection test in a database.
S2. The inspection system according to embodiment S1, wherein the inspection system is further configured to automatically generate an electronic invoice according to one or more parameters related to a generated inspection report, and communicate the electronic invoice to a third party according to predetermined standards.
S3. The inspection system according to embodiment S1 or S2, wherein the inspection system is further configured to receive a client approval identifier associated with the electronic invoice, automatically determine an approval status of the electronic invoice according to predetermined standards, and store the approval status in the database.
E1. A method to conduct an on-site inspection of a piece of oilfield equipment comprising:
   a. providing an electronic inspection system comprising an interface device comprising a portable electronic device interfaced with an electronic database of a central computer system via wired electronic communication, wireless electronic communication, cloud-based electronic communication, internet based electronic communication, email communication, or a combination thereof; and
   b. utilizing electronic storage and electronic communication between the interface device and the central computer system for:
   i. receiving a request to inspect a piece of equipment
   ii. entering the request to inspect the piece of equipment into the electronic database;
   iii. receiving information from an inspector via the interface device associated with an identity of the piece of equipment;
   iv. identifying the piece of equipment in the electronic database or receiving input from the inspector via the interface device to include the piece of equipment in the electronic database;
   v. automatically determining an appropriate inspection method for the piece of equipment based on the identification of the piece of equipment according to one or more predetermined standards;
   vi. determining if the inspector has a certification to conduct the determined inspection method according to one or more predetermined standards;
   vii. if the inspector is determined not to have the certification to conduct the determined inspection method, providing an indication to the inspector via the interface device not to conduct the inspection, and automatically preventing the interface device from generating an electronic inspection ticket on the interface device for the determined inspection method, thereby preventing the inspector from inspecting the piece of equipment according to the determined inspection method;
   viii. if the inspector is determined to have the certification to conduct the determined inspection method, automatically generating the electronic inspection ticket on the interface device for conducting the determined inspection method on the piece of equipment, thereby allowing the inspector to inspect the piece of equipment according to the determined inspection method;
   ix. receiving into the electronic database, inspection information entered by the inspector into one or more required fields of the electronic inspection ticket via the interface device relative to the inspection of the piece of equipment according to the determined inspection method;
   x. automatically determining an acceptability or an unacceptability for use of the piece of equipment for an intended purpose according to the determined inspection method, based on the inspection information entered into the one or more required fields of the electronic inspection ticket by the inspector; and
   xi. storing the inspection information and the determination of the acceptability or unacceptability for use of the piece of equipment for the intended purpose according to the determined inspection method in the electronic database associated with the identification of the piece of equipment, and further associated with a time stamp, a revision number, an author, a geographical location, or a combination thereof.
E2. The method according to embodiment E1, wherein the receiving inspection information entered by the inspector into one or more required fields of the electronic inspection ticket via the interface device is prevented from proceeding to automatically determining the acceptability or the unacceptability for use of the piece of equipment for the intended purpose according to the determined inspection method until all the required fields of the electronic inspection ticket are populated according to the determined inspection method.
E3. The method according to embodiment E1 or embodiment E2, wherein the electronic storage and electronic communication between the interface device and the central computer system further comprises:
   I. receiving information from the inspector via the interface device related to an identity of an inspection instrument designated by the inspector for use in inspecting the piece of equipment according to the determined inspection method;
   II. identifying the inspection instrument in the electronic database or receiving input from the inspector via the interface device to include the inspection instrument in the electronic database;
   III. automatically determining if the identified inspection instrument is in proper calibration according to the determined inspection method;
   IV. if the identified inspection instrument is determined to be in proper calibration according to the determined inspection method, automatically generating the electronic inspection ticket on the interface device for conducting the determined inspection method on the piece of equipment;
   V. if the identified inspection instrument is determined not to be in proper calibration according to the determined inspection method, providing an indication to the inspector that the identified inspection instrument is not in proper calibration, preventing the generation of the electronic inspection ticket, and optionally generating an electronic calibration ticket for calibrating the identified inspection instrument according to predefined standards, thereby preventing the inspector from conducting the determined inspection method and optionally allowing the inspector to calibrate the inspection instrument according to the determined inspection method, followed by again determining if the identified inspection instrument is in proper calibration according to the determined inspection method.
E4. The method according to embodiment E3, wherein the determining if the identified inspection instrument is in proper calibration according to the determined inspection method comprises performing a system effectiveness test according to predefined standards, entering data from the system effectiveness test into one or more required fields of the calibration ticket via the interface device, and determining an acceptability or an unacceptability of the calibration of the identified inspection instrument for conducting the determined inspection method according to predefined standards, based on the data entered into the one or more required fields of the calibration ticket by the inspector.
E5. The method according to any one of embodiments E1 through E4, wherein the request received to inspect the piece of equipment is an automated request originated by the electronic database according to one or more predetermined standards, a period of time, an actual usage, a calculated usage, or a combination thereof.
E6. The method according to any one of embodiments E1 through E5, wherein:
   the receiving a request to inspect a piece of equipment;
   the entering the request to inspect the piece of equipment into the electronic database;
   the receiving information from an inspector via the interface device associated with an identity of the piece of equipment;
   the identifying the piece of equipment in the electronic database or the receiving input from the inspector via the interface device to include the piece of equipment in the electronic database;
   the automatically determining the appropriate inspection method for the piece of equipment based on the identification of the piece of equipment according to one or more predetermined standards;
   the identifying of the inspector by biometric indication;
   the determining if the inspector has a certification to conduct the determined inspection method according to one or more predetermined standards;
   the providing the indication to the inspector via the interface device not to conduct the inspection, and the automatically preventing the interface device from generating an electronic inspection ticket on the interface device for the determined inspection method, thereby preventing the inspector from inspecting the piece of equipment according to the determined inspection method if the inspector is determined not to have the certification to conduct the determined inspection method;
   the automatically generating the electronic inspection ticket on the interface device for conducting the determined inspection method on the piece of equipment, thereby allowing the inspector to inspect the piece of equipment according to the determined inspection method if the inspector is determined to have the certification to conduct the determined inspection method;
   the receiving into the electronic database, inspection information entered by the inspector into the one or more required fields of the electronic inspection ticket via the interface device relative to the inspection of the piece of equipment according to the determined inspection method;
   the automatically determining the acceptability or the unacceptability for use of the piece of equipment for the intended purpose according to the determined inspection method, based on the inspection information entered into the one or more required fields of the electronic inspection ticket by the inspector;
   the storing the inspection information and the determination of the acceptability or unacceptability for use of the piece of equipment for the intended purpose according to the determined inspection method in the electronic database associated with the identification of the piece of equipment and further associated with a time stamp, a revision number, an author, a geographical location, or a combination thereof; consists essentially of electronic storage, electronic communication, or a combination thereof.
E7. The method according to any one of embodiments E1 through E6, wherein the one or more predetermined standards, the one or more determined inspection methods, or a combination thereof, comprise legislated standards, standards adopted or recommended by one or more governmental agencies, trade agencies, API standards, ASNT standards, OSHA standards, or a combination thereof.
E8. The method according to any one of embodiments E1 through E7, further comprising:
   creating a digital billing authorization for the inspection associated with the inspection information relative to the piece of equipment in the electronic database; receiving a billing authorization for the digital billing authorization into the electronic database via the interface device, or a combination thereof.
E9. The method according to any one of embodiments E1 through E8, wherein the inspection information relative to the piece of equipment received into the electronic database, the information relative to the piece of equipment already present in the electronic database, or a combination thereof, includes an electronic image of the piece of equipment.
E10. The method according to any one of embodiments E1 through E9, wherein the inspection information relative to the piece of equipment in the electronic database, the information relative to the piece of equipment already present in the electronic database, or a combination thereof, is associated with a serialized list, an equipment status, a repair history, a calibration schedule, an employee, a biometric indicator, a master item list, a content management list, a user permission, an email address, a certification, an equipment assignment, an equipment location, an employee location, a geographical location, a regulatory requirement, or a combination thereof.
E11. The method according to any one of embodiments E1 through E10, further comprising physically marking the piece of equipment with an indication related to the acceptability or the unacceptability for use of the piece of equipment for the intended purpose according to the determined inspection method.
E12. The method according to any one of embodiments E1 through E11, wherein the electronic database comprises a plurality of interrelated electronic databases.
E13. The method according to any one of embodiments E1 through E12, further comprising:
   providing access to an authorized party to at least a portion of the inspection information relative to the piece of equipment in the electronic database, to information relative to the piece of equipment already present in the electronic database, or a combination thereof.
E14. The method according to embodiment E13, wherein the authorized party is an equipment manufacturer, an owner or assignee of the piece of equipment, a regulatory agency, a trade organization, or any combination thereof.
E15. The method according to embodiment E14, wherein the portion of the inspection information relative to the piece of equipment in the electronic database, the portion of information relative to the piece of equipment already present in the electronic database, or a combination thereof, which is provided to the authorized party is based on a previously defined relationship between the authorized party and the piece of equipment.
E16. The method according to any one of embodiments E1 through E15, wherein the inspector is identified by providing a biometric identifier to the interface device comprising a fingerprint scan, a retinal scan, voice recognition, or a combination thereof.
C1. An inspection system comprising:
   a central computer system comprising an electronic database in communication with a portable electronic device, the system configured to conduct the method according to any one of embodiments E1 through E16.
C2. An inspection system comprising:
   a central computer system comprising an electronic database in communication with a portable electronic device, the system configured to:
   i. receive a request to inspect a piece of equipment
   ii. receive an entry of the request to inspect the piece of equipment into the electronic database;
   iii. receive information from an inspector via the interface device associated with an identity of the piece of equipment;
   iv. identify the piece of equipment in the electronic database or receiving input from the inspector via the interface device to include the piece of equipment in the electronic database;
   v. automatically determine an appropriate inspection method for the piece of equipment based on the identification of the piece of equipment according to one or more predetermined standards;
   vi. determine if the inspector has a certification to conduct the determined inspection method according to one or more predetermined standards;
   vii. if the inspector is determined not to have the certification to conduct the determined inspection method, provide an indication to the inspector via the interface device not to conduct the inspection, and automatically prevent the interface device from generating an electronic inspection ticket on the interface device for the determined inspection method, thereby preventing the inspector from inspecting the piece of equipment according to the determined inspection method;
   viii. if the inspector is determined to have the certification to conduct the determined inspection method, automatically generate the electronic inspection ticket on the interface device for conducting the determined inspection method on the piece of equipment, thereby allowing the inspector to inspect the piece of equipment according to the determined inspection method;
   ix. receive into the electronic database, inspection information entered by the inspector into one or more required fields of the electronic inspection ticket via the interface device relative to the inspection of the piece of equipment according to the determined inspection method;
   x. automatically determine an acceptability or an unacceptability for use of the piece of equipment for an intended purpose according to the determined inspection method, based on the inspection information entered into the one or more required fields of the electronic inspection ticket by the inspector; and
   xi. store the inspection information and the determination of the acceptability or unacceptability for use of the piece of equipment for the intended purpose according to the determined inspection method in the electronic database associated with the identification of the piece of equipment, and further associated with a time stamp, a revision number, an author, a geographical location, or a combination thereof.
C3. The inspection system according to embodiment C2, wherein the electronic storage and electronic communication between the interface device and the central computer system further comprises:
   I. receiving information from the inspector via the interface device related to an identity of an inspection instrument designated by the inspector for use in inspecting the piece of equipment according to the determined inspection method;
   II. identifying the inspection instrument in the electronic database or receiving input from the inspector via the interface device to include the inspection instrument in the electronic database;
   III. automatically determining if the identified inspection instrument is in proper calibration according to the determined inspection method;
   IV. if the identified inspection instrument is determined to be in proper calibration according to the determined inspection method, automatically generating the electronic inspection ticket on the interface device for conducting the determined inspection method on the piece of equipment;
   V. if the identified inspection instrument is determined not to be in proper calibration according to the determined inspection method, providing an indication to the inspector that the identified inspection instrument is not in proper calibration, preventing the generation of the electronic inspection ticket, and optionally generating an electronic calibration ticket for calibrating the identified inspection instrument according to predefined standards, thereby preventing the inspector from conducting the determined inspection method and optionally allowing the inspector to calibrate the inspection instrument according to the determined inspection method, followed by again determining if the identified inspection instrument is in proper calibration according to the determined inspection method.

While the invention has been illustrated and described in detail in the drawings and foregoing description, the same is to be considered as illustrative and not restrictive in character, it being understood that only some embodiments have been shown and described and that all changes and modifications that come within the spirit of the inventions are desired to be protected. It should be understood that while the use of words such as preferable, preferably, preferred, more preferred or exemplary utilized in the description above indicate that the feature so described may be more desirable or characteristic, nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A method to conduct an on-site inspection of a piece of oilfield equipment comprising:
a. providing an electronic inspection system comprising an interface device comprising a portable electronic device interfaced with an electronic database of a central computer system via wired electronic communication, wireless electronic communication, cloud-based electronic communication, internet based electronic communication, email communication, or a combination thereof; and
b. utilizing electronic storage and electronic communication between the interface device and the central computer system for:
i. receiving a request to inspect a piece of equipment;
ii. entering the request to inspect the piece of equipment into the electronic database;
iii. receiving information from an inspector via the interface device associated with an identity of the piece of equipment;
iv. identifying the piece of equipment in the electronic database or receiving input from the inspector via the interface device to include the piece of equipment in the electronic database;
v. automatically determining an appropriate inspection method for the piece of equipment based on the identification of the piece of equipment according to one or more predetermined standards;
vi. determining if the inspector has a certification to conduct the determined inspection method according to one or more predetermined standards;
vii. if the inspector is determined not to have the certification to conduct the determined inspection method, providing an indication to the inspector via the interface device not to conduct the inspection, and automatically preventing the interface device from generating an electronic inspection ticket on the interface device for the determined inspection method, thereby preventing the inspector from inspecting the piece of equipment according to the determined inspection method;
viii. if the inspector is determined to have the certification to conduct the determined inspection method, automatically generating the electronic inspection ticket on the interface device for conducting the determined inspection method on the piece of equipment, thereby allowing the inspector to inspect the piece of equipment according to the determined inspection method;
ix. receiving into the electronic database, inspection information entered by the inspector into one or more required fields of the electronic inspection ticket via the interface device relative to the inspection of the piece of equipment according to the determined inspection method;
x. automatically determining an acceptability or an unacceptability for use of the piece of equipment for an intended purpose according to the determined inspection method, based on the inspection information entered into the one or more required fields of the electronic inspection ticket by the inspector; and
xi. storing the inspection information and the determination of the acceptability or unacceptability for use of the piece of equipment for the intended purpose according to the determined inspection method in the electronic database associated with the identification of the piece of equipment, and further associated with a time stamp, a revision number, an author, a geographical location, or a combination thereof.

2. The method of claim 1, wherein the receiving inspection information entered by the inspector into one or more required fields of the electronic inspection ticket via the interface device is prevented from proceeding to automatically determining the acceptability or the unacceptability for use of the piece of equipment for the intended purpose according to the determined inspection method until all the required fields of the electronic inspection ticket are populated according to the determined inspection method.

3. The method of claim 1, wherein the electronic storage and electronic communication between the interface device and the central computer system further comprises:
I. receiving information from the inspector via the interface device related to an identity of an inspection instrument designated by the inspector for use in inspecting the piece of equipment according to the determined inspection method;
II. identifying the inspection instrument in the electronic database or receiving input from the inspector via the interface device to include the inspection instrument in the electronic database;
III. automatically determining if the identified inspection instrument is in proper calibration according to the determined inspection method;
IV. if the identified inspection instrument is determined to be in proper calibration according to the determined inspection method, automatically generating the electronic inspection ticket on the interface device for conducting the determined inspection method on the piece of equipment;
V. if the identified inspection instrument is determined not to be in proper calibration according to the determined inspection method, providing an indication to the inspector that the identified inspection instrument is not in proper calibration, preventing the generation of the electronic inspection ticket, and optionally generating an electronic calibration ticket for calibrating the identified inspection instrument according to predefined standards, thereby preventing the inspector from conducting the determined inspection method and optionally allowing the inspector to calibrate the inspection instrument according to the determined inspection method, followed by again determining if the identified inspection instrument is in proper calibration according to the determined inspection method.

4. The method of claim 3, wherein the determining if the identified inspection instrument is in proper calibration according to the determined inspection method comprises performing a system effectiveness test according to predefined standards, entering data from the system effectiveness test into one or more required fields of the calibration ticket via the interface device, and determining an acceptability or an unacceptability of the calibration of the identified inspection instrument for conducting the determined inspection method according to predefined standards, based on the data entered into the one or more required fields of the calibration ticket by the inspector.

5. The method of claim 1, wherein the request received to inspect the piece of equipment is an automated request originated by the electronic database according to one or more predetermined standards, a period of time, an actual usage, a calculated usage, or a combination thereof.

6. The method of claim 1, wherein the receiving a request to inspect a piece of equipment; the entering the request to inspect the piece of equipment into the electronic database; the receiving information from an inspector via the interface device associated with an identity of the piece of equipment; the identifying the piece of equipment in the electronic database or the receiving input from the inspector via the interface device to include the piece of equipment in the electronic database; the automatically determining the appropriate inspection method for the piece of equipment based on the identification of the piece of equipment according to one or more predetermined standards; the determining if the inspector has a certification to conduct the determined inspection method according to one or more predetermined standards; if the inspector is determined not to have the certification to conduct the determined inspection method, the providing the indication to the inspector via the interface device not to conduct the inspection, and the automatically preventing the interface device from generating an electronic inspection ticket on the interface device for the determined inspection method, thereby preventing the inspector from inspecting the piece of equipment according to the determined inspection method; if the inspector is determined to have the certification to conduct the determined inspection method, the automatically generating the electronic inspection ticket on the interface device for conducting the determined inspection method on the piece of equipment, thereby allowing the inspector to inspect the piece of equipment according to the determined inspection method; the receiving into the electronic database, inspection information entered by the inspector into the one or more required fields of the electronic inspection ticket via the interface device relative to the inspection of the piece of equipment according to the determined inspection method; the automatically determining the acceptability or the unacceptability for use of the piece of equipment for the intended purpose according to the determined inspection method, based on the inspection information entered into the one or more required fields of the electronic inspection ticket by the inspector; the storing the inspection information and the determination of the acceptability or unacceptability for use of the piece of equipment for the intended purpose according to the determined inspection method in the electronic database associated with the identification of the piece of equipment and further associated with a time stamp, a revision number, an author, a geographical location, or a combination thereof, consists essentially of electronic storage, electronic communication, or a combination thereof.

7. The method of claim 1, wherein the one or more predetermined standards, the one or more determined inspection methods, or a combination thereof, comprise legislated standards, standards adopted or recommended by one or more governmental agencies, trade agencies, API standards, ASNT standards, OSHA standards, or a combination thereof.

8. The method of claim 1, further comprising:
creating a digital billing authorization for the inspection associated with the inspection information relative to the piece of equipment in the electronic database;
receiving a billing authorization for the digital billing authorization into the electronic database via the interface device, or a combination thereof.

9. The method of claim 1, wherein the inspection information relative to the piece of equipment received into the electronic database, the information relative to the piece of equipment already present in the electronic database, or a combination thereof, includes an electronic image of the piece of equipment.

10. The method of claim 1, wherein the inspection information relative to the piece of equipment in the electronic database, the information relative to the piece of equipment already present in the electronic database, or a combination thereof, is associated with a serialized list, an equipment status, a repair history, a calibration schedule, an employee, a biometric indicator, a master item list, a content management list, a user permission, an email address, a certification, an equipment assignment, an equipment location, an employee location, a geographical location, a regulatory requirement, or a combination thereof.

11. The method of claim 1, further comprising physically marking the piece of equipment with an indication related to the acceptability or the unacceptability for use of the piece of equipment for the intended purpose according to the determined inspection method.

12. The method of claim 1, wherein the electronic database comprises a plurality of interrelated electronic databases.

13. The method of claim 1, further comprising:
providing access to an authorized party to at least a portion of the inspection information relative to the piece of equipment in the electronic database, to information relative to the piece of equipment already present in the electronic database, or a combination thereof.

14. The method according to claim 13, wherein the authorized party is an equipment manufacturer, an owner or assignee of the piece of equipment, a regulatory agency, a trade organization, or any combination thereof.

15. The method according to claim 14, wherein the portion of the inspection information relative to the piece of equipment in the electronic database, the portion of information relative to the piece of equipment already present in the electronic database, or a combination thereof, which is provided to the authorized party is based on a previously defined relationship between the authorized party and the piece of equipment.

16. The method according to claim 1, wherein the inspector is identified by providing a biometric identifier to the interface device comprising a fingerprint scan, a retinal scan, a voice recognition scan, or a combination thereof.

17. An inspection system comprising:
a central computer system comprising an electronic database in communication with a portable electronic device, the system configured to:
i. receive a request to inspect a piece of equipment
ii. receive an entry of the request to inspect the piece of equipment into the electronic database;
iii. receive information from an inspector via the interface device associated with an identity of the piece of equipment;
iv. identify the piece of equipment in the electronic database or receiving input from the inspector via the interface device to include the piece of equipment in the electronic database;
v. automatically determine an appropriate inspection method for the piece of equipment based on the identification of the piece of equipment according to one or more predetermined standards;
vi. determine if the inspector has a certification to conduct the determined inspection method according to one or more predetermined standards;
vii. if the inspector is determined not to have the certification to conduct the determined inspection method, provide an indication to the inspector via the interface device not to conduct the inspection, and automatically prevent the interface device from generating an electronic inspection ticket on the interface device for the determined inspection method, thereby preventing the inspector from inspecting the piece of equipment according to the determined inspection method;
viii. if the inspector is determined to have the certification to conduct the determined inspection method, automatically generate the electronic inspection ticket on the interface device for conducting the determined inspection method on the piece of equipment, thereby allowing the inspector to inspect the piece of equipment according to the determined inspection method;
ix. receive into the electronic database, inspection information entered by the inspector into one or more required fields of the electronic inspection ticket via the interface device relative to the inspection of the piece of equipment according to the determined inspection method;
x. automatically determine an acceptability or an unacceptability for use of the piece of equipment for an intended purpose according to the determined inspection method, based on the inspection information entered into the one or more required fields of the electronic inspection ticket by the inspector; and
xi. store the inspection information and the determination of the acceptability or unacceptability for use of the piece of equipment for the intended purpose according to the determined inspection method in the electronic database associated with the identification of the piece of equipment, and further associated with a time stamp, a revision number, an author, a geographical location, or a combination thereof.

18. The inspection system according claim 17, wherein the electronic storage and electronic communication between the interface device and the central computer system further comprises:
VI. receiving information from the inspector via the interface device related to an identity of an inspection instrument designated by the inspector for use in inspecting the piece of equipment according to the determined inspection method;
VII. identifying the inspection instrument in the electronic database or receiving input from the inspector via the interface device to include the inspection instrument in the electronic database;
VIII. automatically determining if the identified inspection instrument is in proper calibration according to the determined inspection method;
IX. if the identified inspection instrument is determined to be in proper calibration according to the determined inspection method, automatically generating the electronic inspection ticket on the interface device for conducting the determined inspection method on the piece of equipment;
X. if the identified inspection instrument is determined not to be in proper calibration according to the determined inspection method, providing an indication to the inspector that the identified inspection instrument is not in proper calibration, preventing the generation of the electronic inspection ticket, and optionally generating an electronic calibration ticket for calibrating the identified inspection instrument according to predefined standards, thereby preventing the inspector from conducting the determined inspection method and optionally allowing the inspector to calibrate the inspection instrument according to the determined inspection method, followed by again determining if the identified inspection instrument is in proper calibration according to the determined inspection method.
